(19) United States
(12) Patent Application Publication
(10) Pub. No.: US 2003/0129425 A1
(43) Pub. Date: Jul. 10, 2003

(54) High ohm capacitor film

(75) Inventors: Shawn Early, Coventry, RI (US); Jaimy Mauricio, Newport, RI (US); Chris Curry, Exeter, NH (US)

Correspondence Address: Jonathan Bockman, Morrison & Foerster LLP, Suite 300, 1650 Tysons Boulevard, McLean, VA, 22102, US

(73) Assignee: Toray Plastics (America), Inc., North Kingstown, RI

(21) Appl. No.: 10/336,841

(22) Filed: Jan. 6, 2003

Related U.S. Application Data
(60) Provisional application No. 60/344,372, filed on Jan. 4, 2002.

(51) Int. Cl. H01G 2/12

(52) U.S. Cl. 428/457; 361/15; 427/79

(57) ABSTRACT

This invention relates to high ohm capacitor films and methods of making high ohm capacitor films. The capacitor films have a zinc active area and have a resistance specification of 20 ohms or higher. Corrosion of the zinc active area is inhibited.

### FIELD OF THE INVENTION

The present invention relates to high ohm capacitor films and methods of making high ohm capacitor films. More specifically, the present invention relates to capacitor films with a resistance specification of 20 ohms or higher that have a zinc active area.

### BACKGROUND

A need exists for high ohm capacitor films that can be used to produce capacitors with good clearing properties. High ohm capacitor films include capacitor films that have a resistance specification of 20 ohms or higher. These capacitor films are used for a variety of applications in which high-energy discharges occur, including, for example, the Automated External Defibrillator (AED) market.

Typically, a capacitor film comprises a polymer film that has been coated on at least one of its surfaces with one or more metal conductors. The polymer film is the capacitor's dielectric, while the metallized surfaces of the polymer film, when wound or stacked together, are the capacitor's plates. Because the metallized surfaces are separated only by the thin polymer film, with higher operating voltages the dielectric of the capacitor can breach or short between the plates in a particular area, typically minute in relation to the overall surface area of the film, due to foreign particles or micro-imperfections in the polymer film. When a short of this kind occurs in a film with good clearing properties, this momentary short allows the flow of a brief (<20 microseconds) but high current, which vaporizes the metallic film in a confined area. In this way, a capacitor with good clearing properties can heal the site of the breach without measurably decreasing the overall capacitance of the capacitor. Ultimately this effect can cause the dielectric properties of the capacitor to improve.

Currently, high ohm capacitor films with good clearing properties use an aluminum or aluminum alloy active area with a zinc heavy edge design. Aluminum or aluminum alloy layers are utilized because of their good corrosion resistance. However, capacitors operating with alternate current under high voltage can generate a corona effect that can cause aluminum to oxidize and become nonconductive. This oxidization of the capacitor film can cause an undesirable change in the capacitance (ΔC) of a capacitor using such a capacitor film.

Capacitor films with a zinc active area and a zinc heavy edge are typically only used for AC capacitor films with lower, between 5-10 ohms, resistance specifications. Capacitor films with a zinc active area are typically not used for high ohm capacitor films because as resistance values increase, the corrosive properties of zinc increase the resistance values exponentially. The corrosion of the zinc active area affects the resistance properties of the capacitor film and makes controlling the specifications and tolerances of capacitor film designs above 20 ohms difficult. Accordingly, an aluminum or aluminum alloy active area is currently used to avoid the problems associated with zinc in the active area.

A high ohm capacitor film that has a zinc active area and in which corrosion is inhibited provides several advantages over the prior art. As compared to aluminum, a zinc active area can improve the control of ohm variation at high resistance levels and can improve capacitance change vs. time. Further, a zinc active area can be deposited at a higher vacuum level than an aluminum active area, which improves the manufacturing process.

Accordingly, a need exists for a high ohm capacitor film that has the benefits of a zinc active area, but in which the corrosive properties of zinc are inhibited.

### SUMMARY OF THE INVENTION

This invention relates to capacitor films that have high, over 20 ohms, resistance specifications and methods of making these capacitor films. In one embodiment the capacitor film comprises a polymer film and a zinc layer formed on the surface of the polymer film. The zinc layer forms the active area of the capacitor film and the capacitor film has a resistance specification of 20 ohms or higher.

Preferably, the polymer film has a thickness of between 0.6 μm and 50 μm. Preferably, the polymer film is corona treated or plasma treated. Preferably, copper is deposited upon the polymer film to provide nuclei for the formation of the zinc layers. Preferably, the zinc layer is formed using a physical vapor deposition process at a pressure of less than 1×10⁻³ torr. Preferably, the capacitor film has a zinc heavy edge.

Preferably, the capacitor film has a corrosion inhibiting organic layer applied to the zinc layer. Preferably, a cure treatment is applied to the corrosion inhibiting organic layer.

In another embodiment, the method of producing the capacitor includes: 1) providing a polymer film; 2) depositing a nucleation source on a surface of the polymer film; 3) forming a zinc layer on the surface that the nucleation source was applied; 4) applying a corrosion inhibiting organic layer to the zinc layer; and 5) applying a cure treatment to the corrosion inhibiting organic layer.

### BRIEF DESCRIPTION OF THE DRAWING

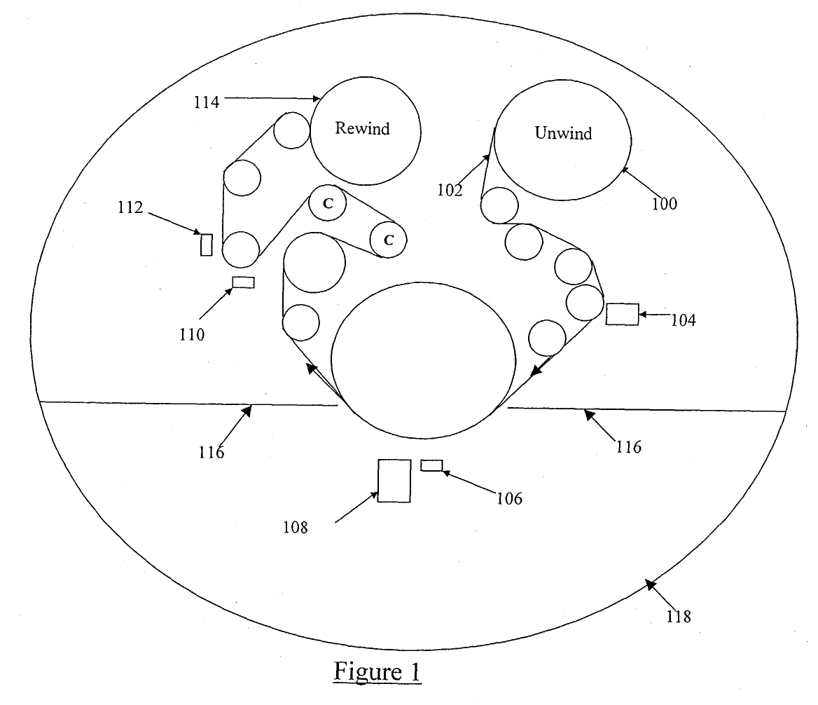

The invention will be better understood by reference to the Detailed Description of the Invention when taken together with the attached FIG. 1, which is a drawing of an apparatus for carrying out a process of this invention.

### DETAILED DESCRIPTION OF THE INVENTION

The invention includes capacitor films that have high, over 20 ohms, resistance specifications and methods of making these capacitor films. The capacitor films include a zinc active area in which corrosion of the zinc is inhibited.

In one embodiment the capacitor film comprises a metallized dielectric film. A preferred dielectric film is a polymer film. Preferably, the metallized polymer film is made by corona treating or plasma treating a polymer film. A nucleation source, such as copper, is then applied to a surface of the polymer film. A zinc active area and heavy edge are then applied to same surface of the polymer film as nucleation source.

Once the zinc active area and heavy edge are applied to the polymer film, a corrosion inhibiting organic layer is applied to the zinc surface and then cured. The process produces a capacitor film that has a zinc active area that can be used for high ohm (greater than 20 ohms) applications.

Preferably, the capacitor film is a dielectric film with one or more metallized surfaces. A preferred dielectric film is a polymer film. The polymer film may be made of natural, semisynthetic or synthetic polymers. Examples of the synthetic polymers include polyolefin resins, polyester resins, polyamide resins, polyimide resins. Polyamideimide resins, polycarbonate resins, polysulfone resins, polyphenylene resins, polyallylate resins, fluorine-contained resins, polystrene resins, and polyallylene resins. In view of mechanical properties and electric properties polypropylenes, polyethylene naphthalates, polyethylene terephthalates, polyphenylenesulfides, polycarbonates and polystyrenes are preferred. The above mentioned polymers may be used individually or in combination.

The thickness of the polymer film is preferably about 0.6 μm to about 50 μm. More preferably, the polymer film has a thickness of about 2 μm to about 25 μm. Most preferably, the polymer film has a thickness of about 3 μm to about 12 μm.

Preferably, a discharge treatment such as a plasma treatment or a corona treatment is performed on one or more surfaces of the polymer film. Plasma and corona treatments can increase the adhesion of a deposited layer to the treated surface. A deposited layer can include, for example, a zinc layer and any nucleation source used for depositing the zinc layer.

A preferred process for plasma treating or corona treating the deposition-side surface of a polymer film is conducted in an inert gas atmosphere with a pressure of about 1.0×10⁻¹ to about 1.0′10⁻³ torr at an intensity of not less than about 5 W min/m² and not greater than about 300 W min/m². A nucleation source and a zinc layer are then preferably deposited on the treated surface with a pressure of less than about 1.0′10⁻³ torr, by an apparatus having a compartment for plasma treatment and one or more compartments for nucleation source deposition and zinc deposition in a single vacuum chamber, the pressure within the compartments being controlled independently from each other.

Preferably, the plasma treatment or corona treatment is conducted in an inert gas atmosphere with a pressure of about 1.0×10⁻¹ to about 1.0×10⁻³ torr. If the pressure is greater than 1.0×10⁻¹ torr, the increase in adhesion of the nucleation source and or zinc layer due to the treatment is insufficient. If the pressure is less than about 1.0×10⁻³ torr, the discharge becomes nonuniform and the treatment again becomes insufficient.

In order to conduct the treatment uniformly in such an atmosphere, an apparatus wherein the substantial length of an electron beam from a discharge electrode is lengthened (a so-called, magnetron) is preferably used. The inert gas is a gas containing not less than about 99% in volume ratio of an element selected from group VIII in the periodic table. Argon is a preferable inert gas from the viewpoint of handling ability etc. The amount of a gas containing oxygen such as oxygen gas, carbon monoxide gas or carbon dioxide gas is preferably suppressed to a volume ratio of not greater than about 0.1%.

The plasma or corona treatment is preferably conducted at an intensity of not less than about 5 W min/m² and not greater than about 300 W mini/m². If the intensity is less than 5 W min/m², the effect of the treatment is insufficient. If the intensity is greater than 300 W min/m², the film can decompose, adversely affecting the film properties.

Preferably, a nucleation source is deposited on the surface of the dielectric film prior to deposition of the zinc layer. A preferable nucleation source includes a metal selected from the group consisting of gold, silver, copper, nickel and tin. More preferably, the nucleation source is copper.

Preferably, the nucleation source is deposited on the dielectric film at a deposition amount of not less than about 0.1 mg/m² and not greater than about 50 mg/m². Preferably, the nucleation source is applied to the dielectric film by vacuum deposition prior to vacuum deposition of a zinc layer. The deposition amount can be determined by secondary ion mass spectrum analysis (so-called SIMS), and the above range of the deposition amount corresponds to the range of the peak intensity of the nucleation source element of about 10 to about 10⁵ counts when the capacitor film is analyzed in the thickness direction from the surface of the zinc deposited layer after the zinc deposition is conducted (the conditions of the analysis are described hereinafter in the description of methods for estimating characteristics.).

As a nucleation source, copper among the above metals is more preferred because it is easily deposited. The pressure for the deposition of the nucleation source is preferably not greater than about 5.0×10⁻⁴ torr. The process for this deposition is not particularly restricted. Namely, although broadly used processes such as crucible and heater systems or wire feeder and heater systems can be applied when the production is industrially performed, the process for the deposition is not restricted to these systems.

After the deposition of the nucleation source, zinc is deposited upon the nucleation source. Preferably, the thickness of the zinc active area is controlled and measured by resistance. Preferably, the resistance is about 10 Ω to about 500 Ω, which corresponds to a thickness of about 200 to about 30 Angstroms. More preferably, the resistance of the zinc active area is about 50 Ω to about 250 Ω. Most preferably, the resistance of the zinc active area is about 75 Ω to about 200 Ω. If the resistance is too high, then the flow of electrons through the conductive active area will be inhibited. If the resistance of the active area is too low then the “clearing” or self-healing ability of the capacitor will be reduced. This clearing ability of the capacitor is important in establishing a strong dielectric strength of the base material.

Dielectric strength is an important characteristic of a high energy density capacitor. Electrical breakdown (failure of the dielectric material in the capacitor) occurs when the applied voltage can no longer be maintained stable without excessive current flow and physical disruption. This failure of the dielectric material, due to high voltage stress, is called voltage breakdown. Dielectric strength is measured according to ASTM D149 using an AC voltage source increased at a constant rate across a dielectric of known thickness. Preferably, suitable organic polymeric dielectric materials of the present invention have a dielectric strength of at least about 250 V/:m, and more preferably, at least about 400 V/:m.

Preferably, a zinc heavy edge is also applied. Preferably, the thickness of the zinc heavy edge is controlled and measured by resistance. Preferably, the resistance is less than about 5 Ω. More preferably, the resistance of the zinc heavy edge is about 1 Ω to about 5 Ω. Most preferably, the resistance of the zinc heavy edge is about 1.3 Ω to about 3 Ω. The function of the heavy edge is to provide good contact with the leads of the capacitor. If the resistance is too high, then the flow of electrons through the conductive active area will be inhibited providing poor contact with the leads of the capacitor. Theoretically, the lower the resistance of the heavy edge the better, however, excessive amounts of zinc may flake off.

The pressure for the zinc deposition is preferably about 1×10⁻² torr or less. More preferably the pressure for the zinc deposition is between about 1×10⁻³ and about 1×10⁻⁵ torr. Most preferably the atmosphere for the zinc deposition is between about 1×10⁻³ and about 5.0×10⁻⁴ torr. Lower pressures are preferred for the zinc deposition, however, lower pressures are more difficult to maintain.

Also in the zinc deposition, although broadly used processes such as crucible and heater systems or wire feeder and heater systems can be used when the production is industrially performed, the process for the deposition is not restricted to these systems.

The nucleation source deposition and the zinc deposition is preferably continuously conducted by, for example, use of a vacuum chamber having two evaporation sources therein. Alternatively, the depositions may be sequentially conducted by two steps of making a nucleation source deposited film and thereafter depositing zinc on the film by usual processes. The former continuous process is preferable from the point of view of productivity.

The zinc deposition and/or nucleation source deposition is preferably performed in succession to the above described discharge treatment under reduced pressure without returning the reduced pressure to atmospheric pressure. For this, an apparatus which has a compartment for discharge treatment and a compartment for deposition in a single vacuum chamber and in which the pressure in each compartment is independently controlled is preferred. Such an apparatus can be provided, for example, by reconstructing a usual continuously winding type vacuum deposition apparatus having two separate compartments for winding and deposition such that the pressure in the compartment for winding can be independently controlled. In addition, the compartment for winding can be used as a compartment for the discharge treatment by providing a plasma or corona generator in the compartment. In the alternative, a third compartment can be added between an unwinding compartment and the compartment for deposition in the usual deposition apparatus. This third compartment can be used as a compartment for discharge treatment with a means for controlling the pressure in the discharge compartment independently from the other compartments. However the apparatus for forming the capacitor film is not restricted to these apparatuses.

Preferably, corrosion of the zinc active area is further inhibited by coating the metallized film with a corrosion inhibiting organic layer. The organic material constituting the organic layer may preferably be an organic substance having a low solubility in water. Especially preferred are lipophilic low molecular substances or oils. Examples of preferred organic materials for the organic layer include silicone oils, fluorine-contained oils, polyalkylnaphthalene oils, petroleum fractions, mineral oils, microcrystalline waxes, polyolefin waxes, paraffin waxes and the like. In view of the promotion of moisture resistance, especially preferred are dimethylpolysiloxane oils and methylphenylpolysiloxane oils, as well as modified silicones, fluorinated silicone oils and perfluoroolefin oils, which have hydrodiene groups, carboxyl groups and the like as reactive groups. If the amount of the organic material constituting the organic layer is too small, promotion of the moisture resistance is not attained, while if it is too large, the surface of the film is sticky reducing the adhesiveness of the film. Therefore, the amount of the organic material should be appropriately selected. Preferably, the organic layer is about 0.0005 μm to about 0.05 μm thick. More preferably, the organic layer is about 0.001 μm to about 0.01 μm thick.

Preferably, a cure treatment is applied to the corrosion inhibiting organic layer. After applying the corrosion inhibiting organic layer on the zinc layer, it can be cured or hardened by any of several methods such as, for example, exposure of the corrosion inhibiting organic layer to heat or radiation (e.g. ultraviolet, electron beam, and the like). The cure treatment is typically applied at a pressure in the range of about 1×10⁻¹ torr to about 10×10⁻³ torr and is used for corrosion inhibiting organic layers that contain double bonds (tung oil, for example).

### EXAMPLE

FIG. 1 shows an apparatus for performing a preferred method for manufacturing the capacitor film of this invention. In FIG. 1, a polymer film 102 is taken from polymer film roll 100. Preferably, the polymer film has a thickness of between about 3 μm and about 15 μm. The polymer film progresses to position 104 where polymer film 102 is corona treated or plasma treated to promote adhesion of the metallized layers to the polymer surface Polymer film 102 next progresses to station 106 where copper, which is used as a nucleation source for the zinc deposition, is deposited onto a surface of the polymer film 102 using a physical vapor deposition process. The amount of copper that is deposited onto the surface of polymer film 102 is adjusted to promote adhesion of the zinc to the polymer surface.

Following the deposition of copper at 106, a zinc layer comprising a zinc active area and a zinc heavy edge is applied on top of the copper surface of polymer film 102 at position 108. The zinc layer is applied at position 108 using a physical vapor deposition process. Once the zinc layer is applied to the polymer film 102, the polymer film 102 progresses to position 110 where a corrosion inhibiting organic layer is applied to the zinc on polymer film 102. Polymer film 102 next progresses to position 112 where a cure treatment for the corrosion inhibiting organic layer is applied to polymer film 102. Once the corrosion inhibiting organic layer is cured at position 112, polymer film 102 is rolled onto capacitor film roller 114. Preferably, the process shown in FIG. 1 occurs in a vacuum chamber 118 with a pressure less than about 1×10⁻³ torr in the lower chamber and less than about 1×10⁻² torr in the upper chamber. A separation plate 116 separates upper and lower chambers.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations. Persons skilled in the art will recognize that the numerical ranges disclosed inherently support any range within the disclosed numerical ranges even though a precise range limitation is not stated verbatim in the specification because this invention can be practiced throughout the disclosed numerical ranges.

What is claimed is:

1. A capacitor film comprising:
a polymer film; and a
zinc layer formed on the surface of the polymer film, wherein the zinc layer comprises an active area of the capacitor film and wherein the capacitor film has a resistance specification of 20 ohms or higher.

2. The capacitor film of claim 1, wherein the polymer film has a thickness of between 0.6 μm and 50 μm.

3. The capacitor film of claim 1, wherein the polymer film is corona treated or plasma treated.

4. The capacitor film of claim 1, further comprising copper deposited upon the polymer film to provide nuclei for the formation of the zinc layers.

5. The capacitor film of claim 1, wherein the zinc layer is formed using a physical vapor deposition process.

6. The capacitor film of claim 5, wherein the physical vapor deposition process occurs at a pressure of less than 1×10⁻³ torr.

7. The capacitor film of claim 1, further comprising a corrosion inhibiting organic layer applied to the zinc layer.

8. The capacitor film of claim 7, wherein a cure treatment is applied to the corrosion inhibiting organic layer.

9. The capacitor film of claim 1, further comprising a zinc heavy edge.

10. A method of producing a capacitor film comprising:
providing a polymer film;
depositing a nucleation source on a surface of the polymer film;
forming a zinc layer on the surface to which the nucleation source was applied;
applying a corrosion inhibiting organic layer to the zinc layer; and
applying a cure treatment to the corrosion inhibiting organic layer.

11. The method of claim 10, wherein the polymer film has a thickness of between 0.6 μm and 50 μm.

12. The method of claim 10, further comprising corona or plasma treating the polymer film prior to depositing the nucleation source on a surface of the polymer film.

13. The method of claim 10, wherein the forming of the zinc layer is preformed using a physical vapor deposition process.

13. The method of claim 12, wherein the zinc layer is formed at a pressure of less than 1×10⁻³ torr.

14. The method of claim 10, wherein the zinc layer comprises a zinc active area and a zinc heavy edge.
